(19) United States
(12) Patent Application Publication
(10) Pub. No.: US 2024/0302406 A1
(43) Pub. Date: Sep. 12, 2024

(54) METHOD AND DEVICE FOR PROCESSING SENSOR SIGNALS OF A SENSOR UNIT FOR A VEHICLE AND SENSOR SYSTEM FOR A VEHICLE

(71) Applicant: Robert Bosch GmbH, Stuttgart (DE)

(72) Inventors: Jorge Juan Robles, Leonberg (DE); Steffen Baab, Gensingen (DE)

(21) Appl. No.: 18/596,288

(22) Filed: Mar. 5, 2024

(30) Foreign Application Priority Data
Mar. 9, 2023 (DE) 10 2023 202 124.2

(51) Int. Cl. G01P 15/18

(52) U.S. Cl. CPC G01P 15/18

(57) ABSTRACT

A method for processing sensor signals of a sensor unit for a vehicle. The sensor unit has at least two acceleration sensors of the same type. The method includes reading in a first sensor signal from a first acceleration sensor of the sensor unit and at least one other sensor signal from at least one other acceleration sensor of the sensor unit. Each sensor signal represents acceleration data acquired by the corresponding acceleration sensor. A fusion of the sensor signals of the acceleration sensors is performed using a processing specification to generate a processed sensor signal. The processing specification takes into account predefined interference acceleration parameters to which the acceleration sensors are subject when they are installed in the vehicle.

### CROSS REFERENCE

The present application claims the benefit under 35 U.S.C. § 119 of German Patent Application No. DE 10 2023 202 124.2 filed on Mar. 9, 2023, which is expressly incorporated herein by reference in its entirety.

### FIELD

The present invention relates to a method for processing sensor signals of a sensor unit for a vehicle, to a device for processing sensor signals of a sensor unit for a vehicle, and to a sensor system for a vehicle. The present invention also relates to a computer program.

### BACKGROUND INFORMATION

Inertial measuring units can be used in vehicles, for example, in active safety, driver assistance, and highly automated driving applications, and measure the physical movement of the vehicle in terms of acceleration and rotation rates. Such inertial measuring units in the automotive sector can be sensitive to external influences, in particular to vibrations of the surrounding structures, such as the vehicle chassis, housing mechanics, and the like, and to acceleration values caused by the installation position.

### SUMMARY

The present invention provides a method for processing sensor signals of a sensor unit for a vehicle, as well as a device that uses this method, a sensor system for a vehicle, and a corresponding computer program. Advantageous embodiments, developments, and improvements of the device specified are made possible by the measures disclosed herein.

According to embodiments of the present invention, in particular an acceleration sensor arrangement and additionally or alternatively a signal processing, for example a signal processing with a special arrangement of acceleration sensors, for compensating external interference effects on acceleration signals and rotational rate signals of such acceleration sensors can be created. For example, a special arrangement of redundant acceleration sensors in combination with a signal processing method can be provided in order to compensate for interference effects of acceleration signals.

According to an example embodiment of the present invention, a method for processing sensor signals of a sensor unit for a vehicle is presented, wherein the sensor unit has at least two acceleration sensors of the same type, wherein the method has the following steps:

reading in a first sensor signal from a first acceleration sensor of the sensor unit and at least one other sensor signal from at least one other acceleration sensor of the sensor unit, wherein each sensor signal represents acceleration data acquired by the corresponding acceleration sensor; and
performing a fusion of the sensor signals of the acceleration sensors using a processing specification to generate a processed sensor signal, wherein the processing specification takes into account predefined interference acceleration parameters to which the acceleration sensors are subject when they are installed in the vehicle, wherein the interference acceleration parameters represent accelerations occurring due to mechanical vibrations occurring at an installation position of the acceleration sensors in the vehicle and due to a positional relationship of the installation position of the acceleration sensors relative to at least one movement axis of the vehicle.

The vehicle can be a motor vehicle, for example a passenger car, motorcycle, truck, or other commercial vehicle. The acceleration data can have measured values of an acceleration resulting from a translation and additionally or alternatively from a rotation. An acceleration sensor can also be referred to as part of an inertial measuring unit. An inertial measuring unit can bundle sensors for detecting the movement state, for example in 6D, i.e., accelerations with respect to three axes and rotational rates with respect to three axes. The acceleration sensors of the sensor unit can be arranged on a common printed circuit board or circuit board. The vibrations and accelerations represented by the interference acceleration parameters can be superimposed by measurement data of a vehicle movement to be detected represented by the sensor signals. The method can also have a step of providing the processed sensor signal for output to at least one functional unit of the vehicle. The method can also have a step of determining or retrieving the processing specification carried out once or multiple times. In such a step of determining, the processing specification can be determined experimentally and additionally or based on simulation data. In particular, the interference acceleration parameters can be determined in this way. In such a step of retrieving, the processing specification or at least the interference acceleration parameters can be retrieved from a memory.

According to one example embodiment of the present invention, the processing specification can comprise the formation of a weighted arithmetic mean of all sensor signals of the sensor unit read in in the step of reading in. In this case, a weighting factor dependent on the positional relationship of the installation position of the corresponding acceleration sensor relative to movement axes of the vehicle can be assigned to each sensor signal. Such an embodiment offers the advantage that different positions of acceleration sensors within the vehicle can be taken into account and compensated for with respect to the movement axis of the vehicle. In this way, interfering influences in the sensor signals can be reliably minimized or removed.

The mechanical vibrations represented by the interference acceleration parameters of the processing specification can also comprise a mechanical resonance of the sensor unit at the installation position. A mechanical resonance can cause a modal movement of the sensor unit. Such an embodiment offers the advantage that a frequently occurring interference variable in vehicles can be minimized.

In this case, according to an example embodiment of the present invention, the mechanical vibrations can be determined by taking into account mechanical resonance characteristics of the sensor unit, taking into account sensitivities of the acceleration sensors at predefined resonant frequencies, and additionally or alternatively taking into account excitation characteristics at the installation position. The resonance characteristics can, for example, be resonant frequencies and additionally or alternatively amplitudes of the mechanical resonance. The sensitivities can relate to filtering, sensitivity to interference, or the like. The excitation characteristics can indicate whether a resonant frequency can be excited in applications or cases of misuse. Such an embodiment offers the advantage that the interference variable of the mechanical vibrations can be precisely and reliably reduced or eliminated.

Furthermore, the accelerations represented by the interference acceleration parameters of the processing specification can be determined relative to multiple or all movement axes of the vehicle and additionally or alternatively relative to at least one detection direction of the acceleration sensors. Such an embodiment offers the advantage that unwanted acceleration values, which may result from a placement of the sensor unit away from a center of gravity of the vehicle, can be reduced or removed from the sensor signals.

The method according to the present invention can be implemented, for example, in software or hardware or in a mixed form of software and hardware, for example in a control device or a device.

The present invention further provides a device which is designed to carry out, actuate or implement the steps of a variant of a method according to the present invention presented here in corresponding apparatuses. The object of the present invention can also be achieved quickly and efficiently by this design variant of the present invention in the form of a device.

For this purpose, according to an example embodiment of the present invention, the device can have at least one computing unit for processing signals or data, at least one memory unit for storing signals or data, at least one interface to a sensor or an actuator for reading sensor signals from the sensor or for outputting data signals or control signals to the actuator, and/or at least one communication interface for reading or outputting data embedded in a communication protocol. The computing unit can, for example, be a signal processor, a microcontroller or the like, and the memory unit can be a flash memory or a magnetic memory unit. The communication interface can be designed to read or output data wirelessly and/or in a wired form, a communication interface, which can read or output wired data, being able to read these data, for example electrically or optically, from a corresponding data transmission line, or being able to output these data into a corresponding data transmission line.

In the present case, a device can be understood to be an electrical device that processes sensor signals and, on the basis of these signals, outputs control and/or data signals. The device can have an interface that can be designed as hardware and/or software. In a hardware embodiment, the interfaces can, for example, be part of a so-called system ASIC, which contains a wide variety of functions of the device. However, it is also possible for the interfaces to be separate integrated circuits or at least partially consist of discrete components. In the case of a software embodiment being used, the interfaces can be software modules that are present, for example, on a microcontroller in addition to other software modules.

A sensor system for a vehicle is also provided according to the present invention, wherein the sensor system has an embodiment of a device mentioned herein and the sensor unit. In this case, the device and the acceleration sensors of the sensor unit are connected to one another in such a way that they are capable of transmitting signals.

In such a sensor system, an embodiment of a device of the present invention mentioned herein can advantageously be used in order to process the sensor signals of the sensor unit. In particular, interference influences can be compensated for. The device and the sensor unit can be integrated to form an assembly, for example to form a control device or into an existing control device.

According to one embodiment of the present invention, the acceleration sensors of the sensor unit can be arranged symmetrically to a center of gravity of the vehicle and/or an intersection of the movement axes of the vehicle when they are installed in the vehicle. Additionally or alternatively, the acceleration sensors of the sensor unit can be arranged in such a way when they are installed in the vehicle that the mechanical vibrations and accelerations represented by the interference acceleration parameters of the processing specification act on the acceleration sensors in different directions. Such an embodiment offers the advantage that interference effects in acceleration signals can be compensated for, wherein a reduced signal deviation from the physical vehicle movement to actually be measured can be achieved.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described above is advantageous as well, in particular when the program product or program is executed on a computer or a device.

Exemplary embodiments of the present invention are illustrated in the figures and explained in more detail in the following description.

### BRIEF DESCRIPTION OF THE DRAWINGS

FIG. 1 shows a schematic representation of an exemplary embodiment of a sensor system in a vehicle, according to the present invention.

FIG. 2 shows a flow chart of an exemplary embodiment of a method of the present invention for processing sensor signals of a sensor unit for a vehicle.

FIG. 3 shows a schematic representation of a vehicle.

FIG. 4 shows a schematic representation of a vehicle.

FIG. 5 shows a schematic representation of a sensor unit of an exemplary embodiment of a sensor system of the present invention.

FIG. 6 shows a schematic representation of a sensor unit of an exemplary embodiment of a sensor system of the present invention.

FIG. 7 shows a schematic representation of a sensor unit of an exemplary embodiment of a sensor system of the present invention.

### DETAILED DESCRIPTION OF EXAMPLE EMBODIMENTS

Before advantageous exemplary embodiments of the present invention are described below, the background and basic principles of the exemplary embodiments will first be briefly discussed.

High-performance IMUs (inertial measurement units) or acceleration sensors are often used in active safety, driver assistance, and highly automated driving applications to measure the physical movement of a vehicle in terms of acceleration and rotational rates. The IMUs provide functions at the vehicle level that require high signal accuracy and high integrity of the functional reliability (up to ASIL D). Acceleration sensors, which typically detect acceleration and rotational rates, are usually either integrated into an input control unit or fused into the airbag unit (e.g., AB+ device). An important feature of an automotive IMU is its robustness with respect to external influences such as:
localized vibrations of the control unit near the position of the acceleration sensor. Such effects are superimposed on the actual physical vehicle movements, which are to be measured and provided on the vehicle fieldbus.
If the sensor is not placed within the vehicle rotational axes, rotational movements of the vehicle will cause measured accelerations in the acceleration sensor.

The effects of localized vibrations can be addressed, for example, by a robust mechanical control device design that does not respond to the vibration excitation from the chassis at undesired frequencies (e.g., no mechanical resonance in a specific frequency band). Undesired accelerations caused by an off-axis rotational movement can be reduced by arranging the control unit or the sensor unit as close as possible to the center of gravity, which may be difficult to achieve due to installation space limitations and acceptance by original equipment manufacturers. Furthermore, the center of gravity can be corrected for acceleration on the basis of angular velocities (ideally measured in the same sensor).

Mechanical robustness through mechanical design alone can be complicated, because a stiffness and/or mass can be changed, which can lead to higher material costs. Extensive design measures can also be taken to eliminate critical resonances that could influence the sensor signals. Furthermore, positions near the vehicle center of gravity for reducing acceleration signal deviations may be in short supply. Correcting measured translational acceleration signals a_{trans,meas} with simultaneous measured angular velocities Vrst according to

$${a}_{trans} = {a}_{trans , meas} \pm r \frac{{dv}_{rot}}{dt}$$

may be susceptible to errors, because signal noise from the rotational rate channel could be projected into the acceleration signals. Furthermore, possible hardware errors in the rotational rate channel could be mapped to the acceleration channel, which could result in a higher random hardware error metric. According to exemplary embodiments, the aforementioned difficulties can be overcome.

In the following description of advantageous exemplary embodiments of the present invention, the same or similar reference signs are used for the elements shown in the various figures and acting similarly, as a result of which a repeated description of these elements is omitted.

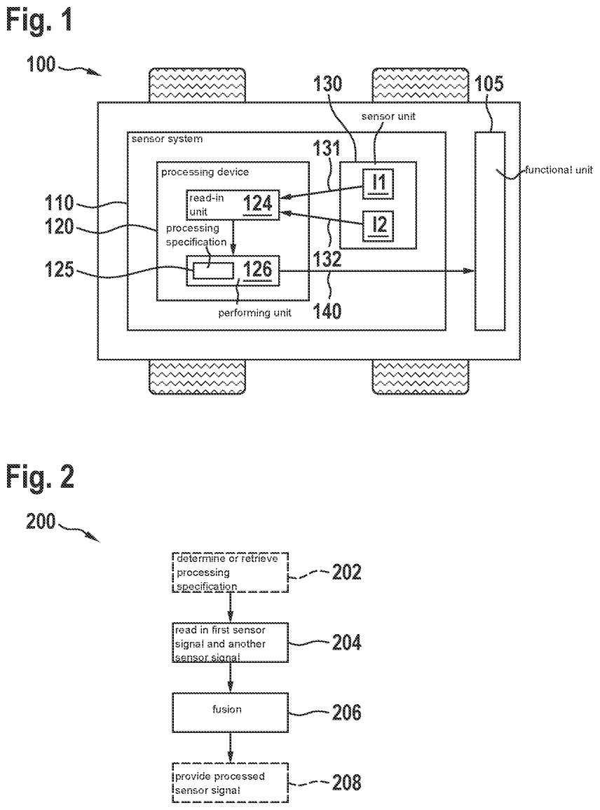

FIG. 1 shows a schematic representation of an exemplary embodiment of a sensor system 110 in a vehicle 100. The vehicle 100 is a motor vehicle, such as a passenger car, a truck, or other commercial vehicle. The sensor system 110 is designed to measure acceleration values of the vehicle 100. The sensor system 110 comprises a device for processing or a processing device 120 and a sensor unit 130. The sensor system 110, and thus the processing device 120 and the sensor unit 130, are installed or mounted in the vehicle 100 in the representation of FIG. 1.

The sensor unit 130 comprises at least two acceleration sensors I1, I2 of the same type. In the representation of FIG. 1, the sensor unit 130 comprises a first acceleration sensor I1 and a second acceleration sensor I2. The first acceleration sensor I1 and the second acceleration sensor I2 are of identical design here. The first acceleration sensor I1 is designed to acquire acceleration data of the vehicle 100 relative to at least one reference axis and to provide it in the form of a first sensor signal 131. The second acceleration sensor I2 is designed to acquire acceleration data of the vehicle 100 relative to at least one reference axis and to provide it in the form of a second sensor signal 132.

The processing device 120 or device and the acceleration sensors I1, I2 of the sensor unit 130 are connected to one another in such a way that they are capable of transmitting signals. The processing device 120 is designed to process the sensor signals 131 and 132 of the sensor unit 130. In particular, the processing device 120 is designed to process the sensor signals 131 and 132 and to generate a processed sensor signal 140 using the sensor signals 131 and 132 and a processing specification 125.

The processing device 120 comprises a read-in unit 124 and a performing unit 126. The processing specification 125 is stored in the processing device 120 or stored in a manner accessible to the processing device 120. The read-in unit 124 is designed to read in the sensor signals 131 and 132 from the sensor unit 130, more precisely from the acceleration sensors I1, I2 of the sensor unit 130. Furthermore, the read-in unit 124 is designed to forward the sensor signals 131 and 132 to the performing unit 126. The performing unit 126 is designed to carry out a fusion of the sensor signals 131 and 132 using the processing specification 125 in order to generate the processed sensor signal 140.

The processing specification 125 takes into account predefined interference acceleration parameters to which the acceleration sensors I1, I2 are subject when they are installed in the vehicle 100. These interference acceleration parameters represent accelerations occurring due to mechanical vibrations occurring at an installation position of the acceleration sensors I1, I2 in the vehicle 100 and due to a positional relationship of the installation position of the acceleration sensors I1, I2 relative to at least one movement axis of the vehicle 100.

According to one exemplary embodiment, the processing specification 125 comprises the formation of a weighted arithmetic mean of all read-in sensor signals 131, 132 of the sensor unit 130. In this case, a weighting factor dependent on the positional relationship of the installation position of the corresponding acceleration sensor I1, I2 relative to movement axes of the vehicle 100 is or will be assigned to each sensor signal 131, 132. In particular, the mechanical vibrations represented by the interference acceleration parameters of the processing specification 125 comprise a mechanical resonance of the sensor unit 130 at the installation position. In this case, the mechanical vibrations are determined, for example, by taking into account mechanical resonance characteristics of the sensor unit 130, sensitivities of the acceleration sensors I1, I2 at predefined resonant frequencies and/or excitation characteristics at the installation position of the sensor unit 130 in the vehicle 100. According to one exemplary embodiment, the accelerations represented by the interference acceleration parameters of the processing specification 105 and 20 are determined relative to multiple or all movement axes of the vehicle 100 and/or relative to at least one detection direction of the acceleration sensors I1, I2.

The processing device 120 is in particular also designed to provide and/or output the processed sensor signal 140 for output to at least one functional unit 105 of the vehicle 100. The at least one functional unit 105 is, for example, a control device, an assistance function, and/or an actuator of the vehicle 100.

According to one exemplary embodiment, the acceleration sensors I1, I2 of the sensor unit 130 are arranged symmetrically with respect to a center of gravity of the vehicle 100 and/or symmetrically with respect to an intersection of the movement axes of the vehicle 100 when they are installed in the vehicle 100. Additionally or alternatively, the acceleration sensors I1, I2 are arranged such that the mechanical vibrations and accelerations represented by the interference acceleration parameters of the processing specification 125 act on the acceleration sensors I1, I2 in different directions. Among other things, this situation will be further illustrated with reference to the following figures.

FIG. 2 shows a flow chart of an exemplary embodiment of a method 200 for processing sensor signals of a sensor unit for a vehicle. The method 200 for processing can be executed in conjunction with the sensor unit from FIG. 1 or a similar sensor unit. In this case, the method 200 for processing can be executed using the processing device or the device for processing from FIG. 1 or a similar device. The method 200 for processing can thus be executed in order to process sensor signals of a sensor unit for a vehicle, wherein the sensor unit has at least two acceleration sensors of the same type. The method 200 for processing comprises a step 204 of reading in and a step 206 of performing.

In the step 204 of reading in, a first sensor signal is read in by a first acceleration sensor of the sensor unit and at least one other sensor signal is read in by at least one other acceleration sensor of the sensor unit. Each sensor signal represents acceleration data acquired by the corresponding acceleration sensor. Subsequently, in the step 206 of performing a fusion of the sensor signals read in in the step 204 of reading in is carried out using a processing specification in order to generate a processed sensor signal. The processing specification takes into account predefined interference acceleration parameters to which the acceleration sensors are subject when they are installed in the vehicle. The interference acceleration parameters represent mechanical vibrations occurring in the vehicle at an installation position of the acceleration sensors. The interference acceleration parameters also represent accelerations occurring relative to at least one movement axis of the vehicle due to a positional relationship of the installation position of the acceleration sensors.

According to one exemplary embodiment, the method 200 for processing also comprises a step 208 of providing the processed sensor signal generated in the step 206 of performing for output to at least one functional unit of the vehicle. Additionally or alternatively, according to one exemplary embodiment, the method 200 for processing comprises a step 202 of determining or retrieving the processing specification. The processing specification is determined experimentally and additionally or based on simulation data or retrieved from a memory. In particular, at least the interference acceleration parameters are determined or retrieved from the memory.

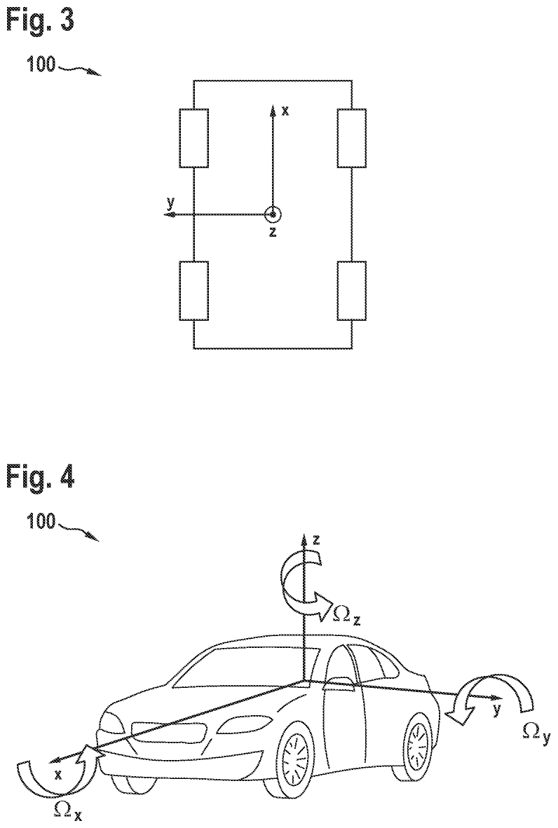

FIG. 3 shows a schematic representation of a vehicle 100. The vehicle 100 is the same as or similar to the vehicle from FIG. 1. The vehicle 100 can thus have an exemplary embodiment of the above-mentioned sensor system. In the representation of FIG. 3, vehicle axes or movement axes x, y, z of the vehicle 100 are shown for illustration purposes. These movement axes comprise a longitudinal axis x, a transverse axis y, and a vertical axis z.

FIG. 4 shows a schematic representation of a vehicle 100. The representation in FIG. 4 is similar to the representation from FIG. 3. Again, the movement axes x, y, z are shown. In addition, rotational accelerations Ωₓ, Ω_{y}, Ω_{z} about the respective movement axes x, y, z are drawn. Thus, a roll acceleration Ωₓ about the longitudinal axis x, a pitch acceleration Ω_{y} about the transverse axis y, and a yaw acceleration Ω_{z} about the vertical axis z are shown.

The movement axes x, y, z and rotational accelerations Ωₓ, Ω_{y}, Ω_{z} shown in FIGS. 3 and 4 are also to be considered in connection with the acceleration sensors of the sensor unit and/or with the processing specification of the processing device of the above-mentioned sensor system.

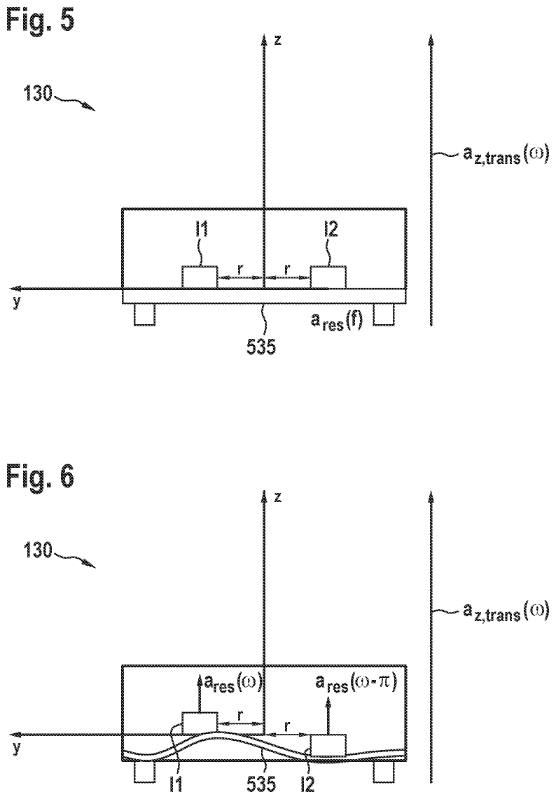

FIG. 5 shows a schematic representation of a sensor unit 130 of an exemplary embodiment of a sensor system. The sensor unit 130 is the same as or similar to the sensor unit of the sensor system from FIG. 1. The sensor unit 130 is designed merely by way of example as a control device or as an electronic control unit (ECU) or part thereof. A first acceleration sensor I1, a second acceleration sensor I2, and a circuit board or printed circuit board 535, on which the acceleration sensors I1 and I2 are arranged, of the sensor unit 130 are shown. Furthermore, movement axes y and z of the vehicle are shown, in this case a transverse axis y and a vertical axis z. The two acceleration sensors I1 and I2 are arranged symmetrically with respect to the vertical axis z, wherein the same distance r exists between the first acceleration sensor I1 and the vertical axis z and between the second acceleration sensor I2 and the vertical axis z. In addition, a translational movement a_{z,trans} (ω) of the vehicle is shown, which runs by way of example along the vertical axis z. FIG. 5 shows a state without mechanical resonance, whereby the acceleration values or acceleration data measured by the acceleration sensors I1 and I2 are a₁₁=a₁₂=a_{z,trans} (ω).

FIG. 6 shows a schematic representation of a sensor unit 130 of an exemplary embodiment of a sensor system. In this case, the representation in FIG. 6 corresponds to the representation from FIG. 5, except that a mechanical resonance state is shown, for example with a second harmonic of the circuit board 535. The mechanical resonance is illustrated by an exaggerated deflection of the circuit board 535. The first acceleration sensor I1 acquires first acceleration data or a first acceleration value aᵣₑₛ (ω) and the second acceleration sensor I2 acquires second acceleration data or a second acceleration value aᵣₑₛ (ω−π).

In particular, with reference to FIG. 5 and FIG. 6, a design approach for the sensor unit 130 for eliminating unwanted accelerations due to mechanical resonances at a specific resonant frequency can be illustrated. The design relates to a mechanical resonance at a specific frequency ω. The actual vehicle movement a_{z,trans} is superimposed by additional accelerations generated by the modal movement of the mechanism, for example the circuit board 535. The redundant acceleration sensors I1, I2 are placed in such a way that the unwanted modal movement acts on the sensors in different directions at a given time, i.e., a phase shift of n is present. The fusion or signal fusion performed by means of the device of the sensor system can be carried out for the situation shown in FIG. 6 as follows: a₁₁=a_{z,trans} (ω)+aᵣₑₛ (ω); a₁₂=a_{z,trans} (ω)+aᵣₑₛ (ω−π)≈a_{z,trans} (ω)−aᵣₑₛ (ω)

$${a}_{trans} = \frac{( {a}_{I 1} + {a}_{I 2} )}{2} = {a}_{z , trans} .$$

The signal fusion is indicated in its simplest form, as a weighted arithmetic mean, where both weights are equal. This can be extended to more highly developed approaches to facilitate the elimination process. Note that is only one specific example that could eliminate a mechanical resonance. For example, a compromise is made between multiple resonances based on multiple characteristics, such as:
the mechanical resonance characteristics of the control device or sensor system, for example resonant frequencies and amplitudes;
sensitivities of the acceleration sensors I1, I2 at the resonant frequencies, for example filtering, sensitivity to interference, etc.; and
excitation characteristics in the installation position in the vehicle, according to the question of whether this frequency can be excited in applications and/or erroneous application.

The fusion of the sensor signals also makes it possible to reduce the expected usual sensor tolerances, for example noise or nonlinear characteristics.

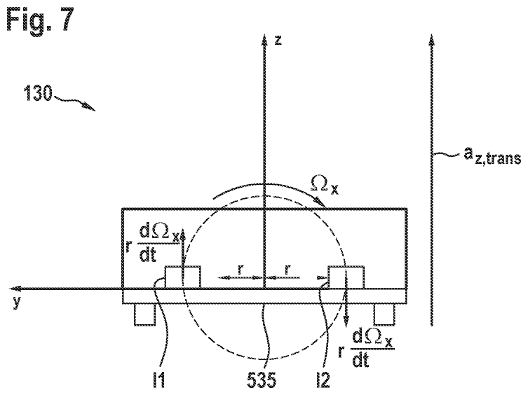

FIG. 7 is a schematic representation of a sensor unit 130 of an exemplary embodiment of a sensor system. The representation in FIG. 7 corresponds to the representation from FIG. 5, except that in addition to the translational movement a_{z,trans} of the vehicle, there is a roll acceleration Q of the vehicle and thus an off-axis rotational movement of the sensor unit 130. In this case, the acceleration sensors I1 and I2 have a trajectory of r_{dt}^{dΩ}^{ₓ} due to the off-axis rotational movement.

In particular, with reference to FIG. 7, a design approach of the sensor unit 130 for eliminating unwanted accelerations due to off-axis rotational movements present at the vehicle level can be

$${a}_{I 1} = {a}_{z , trans} + r \frac{d {Ω}_{x}}{dt} ; \qquad {a}_{I 2} = {a}_{z , trans} - r \frac{d {Ω}_{x}}{dt} ; \qquad {a}_{trans} = \frac{( {a}_{I 1} + {a}_{I 2} )}{2} = {a}_{z , trans} .$$

This approach relates to a specific arrangement with an off-axis rotational movement about the x-axis, i.e., a roll movement of the vehicle. The approach can be extended to any vehicle movement and sensor detection direction. Depending on the spatial position of the control device or the sensor unit 130 in the vehicle, the elimination process can focus on the most dominant unwanted accelerations due to off-axis rotational movement.

With reference to the figures described above, exemplary embodiments are summarized below and briefly explained in other words.

According to exemplary embodiments, a special arrangement of redundant acceleration sensors I1, I2 in combination with a signal processing scheme is in particular provided in order to compensate for interference effects of acceleration signals or sensor signals 131, 132. This arrangement aims to reduce the impact of the following effects: 1) vibration interference caused by mechanical resonances, in particular control device resonances, resulting in specific modal movements of the acceleration sensors I1, I2. 2) unwanted translational acceleration due to an off-axis rotational movement of the sensor unit 130 or sensor system 110 or control device. An ideal condition for compensation by signal processing consists, for example, in aligning the redundant acceleration sensors I1, I2 in such a way that the relevant interference effect acts on the measurement signals or sensor signals 131, 132 in different directions. A continuous fusion of the redundant sensor signals 131, 132 then results in a single corrected signal or processed sensor signal 140, showing a reduced signal deviation from the physical vehicle movement. If the ideal arrangement of the acceleration sensors I1, I2 described above is not possible, different weights can be assigned to the acceleration sensors I1, I2, which weights can be used later during the fusion in order to obtain an unambiguous final processed sensor signal 140, for example by applying a weighted average.

The proposed elimination of unwanted effects on the acceleration signals or sensor signals 131, 132 is based on a specific spatial arrangement of multiple redundant acceleration sensors I1, I2 of the same type on the same circuit board 535 (PCB) and on a signal processing part or processing method 200, wherein the sensor signals 131, 132 are combined. This spatial arrangement is or will be selected in such a way that the interference effect acts on the redundant acceleration sensors I1, I2 in the opposite direction in such a way that said interference effect can be eliminated by continuously fusing the sensor signals 131, 132, e.g. Sig_{final}=weighted average (sig₁, sig₂, etc.).

If an exemplary embodiment has an “and/or” link between a first feature and a second feature, this is to be understood to mean that the exemplary embodiment according to one example has both the first feature and the second feature and, according to a further exemplary example, either only the first feature or only the second feature.

What is claimed is:

1. A method for processing sensor signals of a sensor unit for a vehicle, wherein the sensor unit has at least two acceleration sensors of the same type, wherein the method comprises the following steps:
reading in a first sensor signal from a first acceleration sensor of the sensor unit and at least one other sensor signal from at least one other acceleration sensor of the sensor unit, wherein each sensor signal of the first and other sensor signals represent acceleration data acquired by a corresponding one of the first and other acceleration sensor; and
performing a fusion of the first and other sensor signals using a processing specification to generate a processed sensor signal, wherein the processing specification takes into account predefined interference acceleration parameters to which the first and other acceleration sensors are subject when they are installed in the vehicle, wherein the interference acceleration parameters represent accelerations occurring due to mechanical vibrations occurring at an installation position of the first and other acceleration sensors in the vehicle and due to a positional relationship of the installation position of the first and other acceleration sensors relative to at least one movement axis of the vehicle.

2. The method according to claim 1, wherein the processing specification includes a formation of a weighted arithmetic mean of all read-in sensor signals of the sensor unit, wherein each sensor signal of the read-in sensor signals is assigned a weighting factor dependent on the positional relationship of the installation position of a corresponding acceleration sensor relative to movement axes of the vehicle.

3. The method according to claim 1, wherein the mechanical vibrations represented by the interference acceleration parameters of the processing specification include a mechanical resonance of the sensor unit at the installation position.

4. The method according to claim 3, wherein the mechanical vibrations are determined by taking into account: (i) mechanical resonance characteristics of the sensor unit, and/or (ii) sensitivities of the first and other acceleration sensors at predefined resonant frequencies, and/or (iii) excitation characteristics at the installation position.

5. The method according to claim 1, wherein the accelerations represented by the interference acceleration parameters of the processing specification are determined: (i) relative to multiple or all movement axes of the vehicle, and/or (ii) relative to at least one detection direction of the first and other acceleration sensors.

6. A device configured to process sensor signals of a sensor unit for a vehicle, wherein the sensor unit has at least two acceleration sensors of the same type, the device configured to:
read in a first sensor signal from a first acceleration sensor of the sensor unit and at least one other sensor signal from at least one other acceleration sensor of the sensor unit, wherein each sensor signal of the first and other sensor signals represent acceleration data acquired by a corresponding one of the first and other acceleration sensor; and
perform a fusion of the first and other sensor signals using a processing specification to generate a processed sensor signal, wherein the processing specification takes into account predefined interference acceleration parameters to which the first and other acceleration sensors are subject when they are installed in the vehicle, wherein the interference acceleration parameters represent accelerations occurring due to mechanical vibrations occurring at an installation position of the first and other acceleration sensors in the vehicle and due to a positional relationship of the installation position of the first and other acceleration sensors relative to at least one movement axis of the vehicle.

7. A sensor system for a vehicle, comprising:
a sensor unit including at least two acceleration sensors of the same type; and
a device configured to:
read in a first sensor signal from a first acceleration sensor of the sensor unit and at least one other sensor signal from at least one other acceleration sensor of the sensor unit, wherein each sensor signal of the first and other sensor signals represent acceleration data acquired by a corresponding one of the first and other acceleration sensor, and
perform a fusion of the first and other sensor signals using a processing specification to generate a processed sensor signal, wherein the processing specification takes into account predefined interference acceleration parameters to which the first and other acceleration sensors are subject when they are installed in the vehicle, wherein the interference acceleration parameters represent accelerations occurring due to mechanical vibrations occurring at an installation position of the first and other acceleration sensors in the vehicle and due to a positional relationship of the installation position of the first and other acceleration sensors relative to at least one movement axis of the vehicle;
wherein the device and the acceleration sensors of the sensor unit are connected to one another in such a way that they are capable of transmitting signals.

8. The sensor system according to claim 7, wherein the acceleration sensors of the sensor unit: (i) are arranged symmetrically with respect to a center of gravity of the vehicle and/or an intersection of the movement axes of the vehicle when they are installed in the vehicle, and/or (ii) are arranged in such a way that the mechanical vibrations and accelerations represented by the interference acceleration parameters of the processing specification act on the acceleration sensors in different directions.

9. A non-transitory machine-readable storage medium on which is stored a computer program for processing sensor signals of a sensor unit for a vehicle, wherein the sensor unit has at least two acceleration sensors of the same type, wherein the computer program, when executed by a computer, causing the computer to perform the following steps:
reading in a first sensor signal from a first acceleration sensor of the sensor unit and at least one other sensor signal from at least one other acceleration sensor of the sensor unit, wherein each sensor signal of the first and other sensor signals represent acceleration data acquired by a corresponding one of the first and other acceleration sensor; and
performing a fusion of the first and other sensor signals using a processing specification to generate a processed sensor signal, wherein the processing specification takes into account predefined interference acceleration parameters to which the first and other acceleration sensors are subject when they are installed in the vehicle, wherein the interference acceleration parameters represent accelerations occurring due to mechanical vibrations occurring at an installation position of the first and other acceleration sensors in the vehicle and due to a positional relationship of the installation position of the first and other acceleration sensors relative to at least one movement axis of the vehicle.
